(19) United States
(12) Patent Application Publication
(10) Pub. No.: US 2002/0111181 A1
(43) Pub. Date: Aug. 15, 2002

(54) Apparatus and method for large area radio dispatch communications

(76) Inventors: Brent Jaybush, Los Angeles, CA (US); Han Ki Lee, Cypress, CA (US); Hong Lim, Rosemead, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/076,014

(22) Filed: Feb. 12, 2002

Related U.S. Application Data
(63) Continuation of application No. 09/953,341, filed on Sep. 12, 2001.
(60) Provisional application No. 60/232,021, filed on Sep. 12, 2000.

(51) Int. Cl. H04B 7/00

(52) U.S. Cl. 455/519; 455/517

(57) ABSTRACT

A radio dispatch system has a plurality of base stations covering a large geographic area. The base stations are connected to the Internet so voice messages can be sent between them. Each of a plurality of mobile transceivers is adapted to send voice messages to one of the base stations and receive voice messages from one of the base stations. As a result, the mobile transceivers can communicate with each other and the base stations over a wide geographic area limited only by the reach of the Internet.

### CROSS-REFERENCE TO RELATED APPLICATIONS

This application is a continuation of Application No. 09/953,341, filed Sep. 12, 2001, which claimed the priority of U.S. provisional Application No. 60/232,021, filed Sep. 12, 2000, the disclosures of which are incorporated fully herein by reference.

### BACKGROUND OF THE INVENTION

This invention relates to radio communications, and more particularly, to a wide area radio dispatch system and method capable of operating over a large geographic area.

Radio dispatch technology is used to communicate between a mobile station and fixed stations over short distances, e.g., fifty miles or less. Transmission takes place at low power and low frequency (e.g. below 520 MHz). Most radio dispatch systems employ push-to-talk (PTT) transmission from the mobile stations on one or more channels and continuous transmission on a different frequency from the base station. Typical users for PTT radio dispatch systems are taxis, delivery men, and government workers.

### SUMMARY OF THE INVENTION

According to the invention, a radio dispatch system has a plurality of base stations covering a large geographic area. The base stations are connected to the Internet so voice messages can be sent between them. Each of a plurality of mobile transceivers is adapted to send voice messages to one of the base stations and receive voice messages from one of the base stations. As a result, the mobile transceivers can communicate with each other and the base stations over a wide geographic area limited only by the reach of the Internet.

### BRIEF DESCRIPTION OF THE DRAWINGS

The features of specific embodiments of the best mode contemplated of carrying out the invention are illustrated in the drawings, in which:

FIG. 1 is a diagram of a radio dispatch system that illustrates the principles of the invention;

FIG. 2 is a block diagram of a mobile transceiver constructed in accordance with the principles of the invention; and

FIG. 3 is a block diagram of a base station constructed in accordance with the principles of the invention.

### DETAILED DESCRIPTION OF THE INVENTION

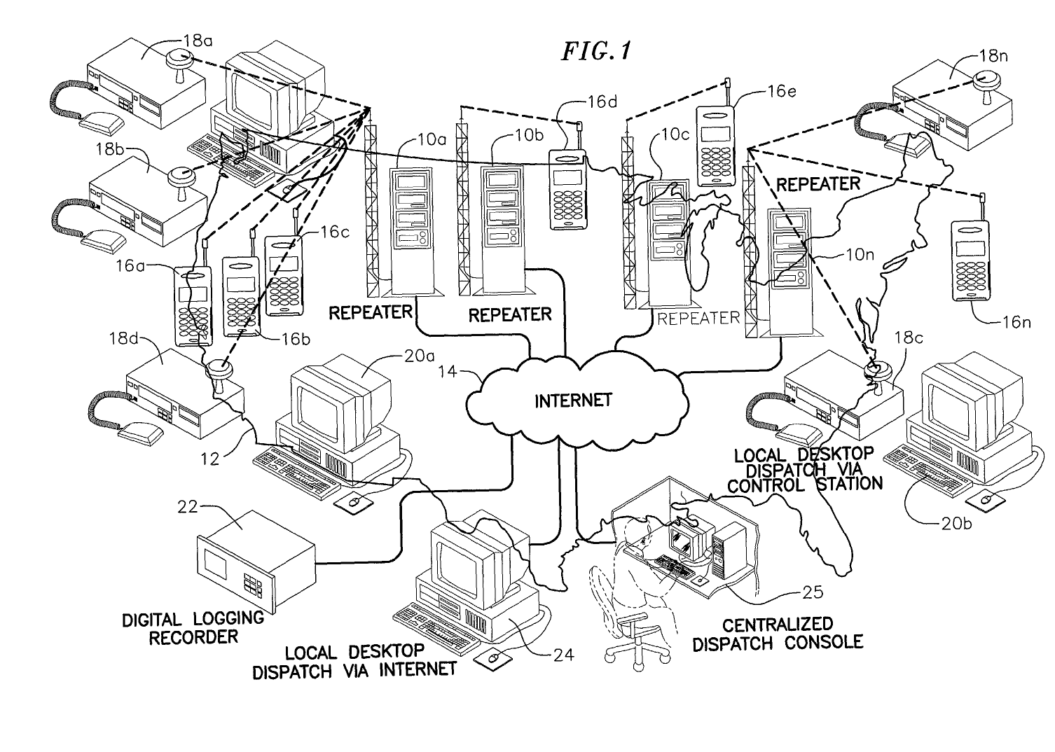

According to the invention, radio dispatch systems operating in different geographic areas called “cells” are interconnected by a wide area network, preferably the Internet. In FIG. 1a plurality of base stations 10a, 10b, 10c . . . , 10n, called repeaters in the drawing because they relay the information being transmitted to another destination, are distributed throughout a large geographic area represented in the drawing by an outline of the United States 12. Normally, there is one base station per cell, unless the traffic load requires more. Base stations 10a to 10n are connected to each other and a number of other accessories to be described via the Internet 14. Hand-held mobile transceivers 16a, 16b, 16c, 16d, 16f . . . , 16n send messages to one of base stations 10a to 10n, depending upon their proximity to the base stations. Within a cell, the mobile stations communicate with each other vis their base station. In addition, mobile transceivers 18a, 18b, 18c, 18d . . . , 18n, which are mounted in vehicles, also communicate with base stations 10a to 10n in the same way as mobile transceivers 16a to 16n. All the mobile transceivers are preferably provided will GPS receivers so the mobile stations can transmit positional information with the voice messages. Mobile transceivers 18c and 18d are preferably provided with displays that overlay positional information about the mobile transceivers as derived from the GPS receivers on a map of the region served by the mobile transceiver.

A digital logging recorder 22 is connected to Internet 14 to receive from each of base stations 10a to 10n a baseband data stream that is raw in the sense that it is recorded in the same data format as it is transmitted. If any of this data is to be recovered later, it can be identified by scanning the headers in the formatted data.

A local desktop dispatch console 24 is connected to Internet 14 to communicate with other resources unconnected to the dispatch network by modem or telephone. For example, fire or police assistance could be initiated from console 24. A centralized dispatch console is also connected to Internet 14 to monitor and manage the traffic on the system.

When a message is sent over Internet 14 to a particular base station, if all the available channels there are in use, the message is stored at the receiving base station so transmission from a base station is never blocked. As soon as a channel becomes available at the receiving base station, the channel is assigned to the stored voice message, which is then sent to its destination mobile transceiver.

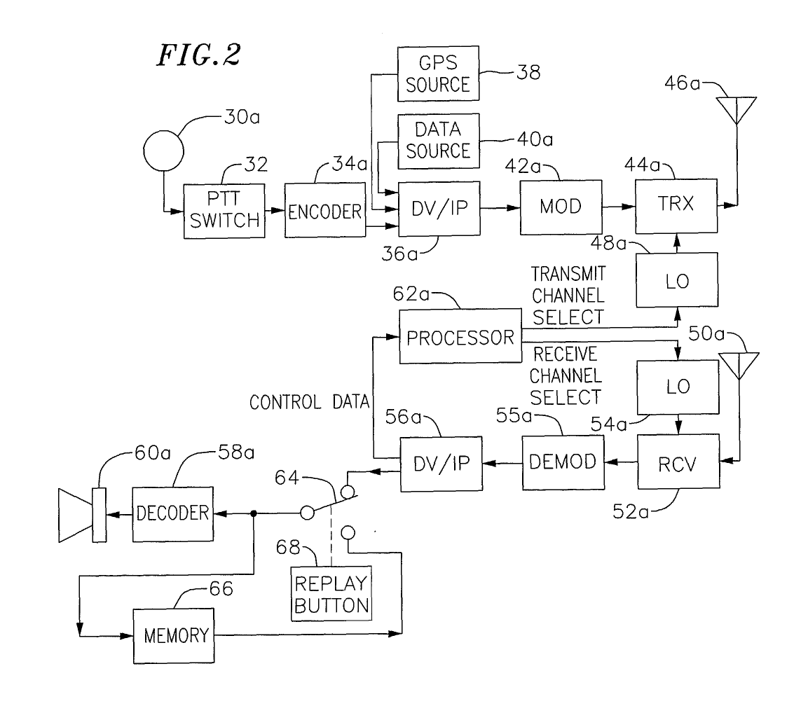

One of the mobile transceivers is shown in FIG. 2. A microphone 30 is coupled by a PTT switch 32 to an encoder (codec) 34a. that digitizes voice messages from microphone 30. Preferably, a four level code is employed; accordingly a pulsed signal having four amplitude levels, preferably at a spacing of 1/60 of a second, is generated by encoder 34a. Encoder 34a is coupled to a DV/IP processor 36. In processor 36, the encoded voice messages are packetized, preferably according to a protocol called digital voice/internet protocol (DV/IP) that is described in the appendix. A source of GPS information 38 and a source or other data 40a are also applied to the input of processor 36. The packetized baseband voice messages, data, and GPS information are coupled to a modulator 42a, where they control the frequency of a local oscillator (not shown). The result is a frequency shift keyed signal that moves among four slightly different frequencies, depending upon the level of the baseband signal. An antenna 46a is driven by the output of transmitter 44a to broadcast the information containing signal throughout the cell in which the mobile transceiver is located. If trunked radio dispatch (multiple channels) is employed, the frequency of a local oscillator 48a varies depending upon the channel assigned to the mobile transceiver. Typically, the channel separation is 10 KHz and the bandwidth of each channel is 6 kHz. Local oscillator 48a is coupled to transmitter 44a to change the frequency of transmission by mixing the frequency shift keyed signal. Alternatively, a single oscillator could be used to perform both the frequency shift keying function and the channel selection function; in this case, programable frequency dividers are disposed in a phase locked loop to change the frequency of transmission to some multiple of a reference oscillator (i.e., a crystal) and the four level baseband signal modulates a varactor capacitor connected in parallel with the reference oscillator.

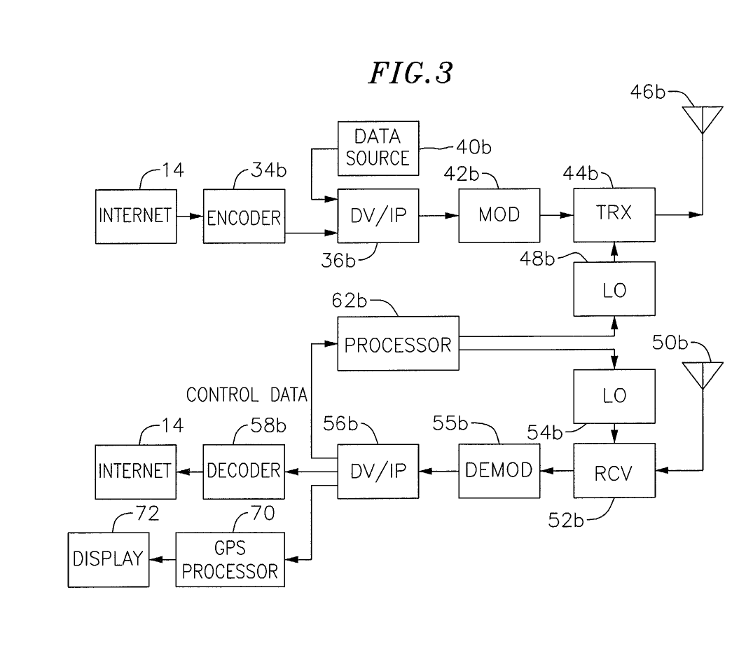

A receiving antenna 50a, which intercepts the signal transmitted from the base station of the cell in which the mobile transceiver is located, couples the intercepted signal to a receiver 52a. The frequency of receiver 52a is heterodyned down in frequency (e.g., to 12.5 KHz) by a local oscillator 54a. A demodulator 54 couples receiver 52a to a DV/IP processor 56a. Demodulator, which could be a conventional frequency discriminator of the type used in commercial FM receivers, converts the four frequency signal at the output of receiver 52a to a four level baseband signal. Processor 56a de-packetizes, i.e., parses, the four level baseband signal according to the DV/IP protocol described in the appendix. As a result, the signal at the output from processor 56a is the same as the signal at the input to a processor 36b at the base station, as discussed below in connection with FIG. 3. In other words, processor 56a performs the reverse operation on the transmitted information from processor 36b. Control data from processor 62a is coupled to the input of a channel selection processor 62a. One output from processor 62a controls the frequency of local oscillator 48a to set the frequency of transmission from the mobile transceiver. The other output from processor 62a controls the frequency of local oscillator 54a to set the frequency of reception by the mobile transceiver. The control data for effecting channel assignment for transmission and reception at the mobile transceiver is sent to the mobile transceiver by the base station. The output of processor 56a is coupled through the normally closed contact of a switch 64 to a decoder (codec) 58a. Although switch 64 is shown schematically in the drawing, it would preferably be an electronic switch, so operations are not unduly delayed. Decoder 58a creates strobe pulses from the incoming signal to detect the four levels, convert them into binary words depending on the level of the incoming signal, and then convert the binary words to an analog signal that replicates the signal applied to the input of an encoder 34b at the base station, as discussed below in connection with FIG. 3. This analog signal from decoder 58a drives a loud speaker 60 to reproduce the voice message sent by the base station. The input to a memory 66, such as a CD ROM, is also connected to the input of decoder 58a and its output is connected to the normally open contact of switch 64. Switch 64 is actuated by depressing a replay button 68. If the user of the mobile transceiver wants to replay a message for any reason, s/he can press replay button 68 and the message is read out of memory 66 and sent to decoder 58a for processing in the described manner. It should be noted that the voice messages are stored in memory 66 in “raw” form, i.e., as four level baseline signals, and are continuously overwritten by new voice messages so the replay capability is temporary.

One of the base stations is shown in FIG. 3. The components in FIG. 3 that bear reference numerals including the letter “b” are functionally the same as the components in FIG. 2 that bear the same reference numerals including the letter “a”. The Internet 14 delivers data in a binary stream to DV/IP processor 36b. Processor 36b is connected to a modulator 42b. A data source 40b is also connected to processor 36b. Part of the data from source 40b is a channel selection schedule. Modulator 42b is coupled to a transmitter 44b, which drives a transmitting antenna 46b. A receiving antenna 50b is coupled by a receiver 52b to a demodulator 54b. Demodulator 54b is coupled to a DV/IP processor 56b. The output of processor 56b is coupled to the Internet to distribute the voice messages to other base stations. Header information from the signal emanating from processor 56b determines the destination of the voice messages being routed to Internet 14. In Internet 14 the data outputted from processor 56b is converted to TCP/IP format. The GPS information at the output of processor 56b is routed to a GPS processor 70, which drives a display 72. Display 72 shows the position of the mobile transceiver that sent the message being processed, preferably overlaid on a map of the region being served by the radio dispatch system or one or more cells thereof.

A feature of the invention is controlling the channel, i.e., frequency, of transmission to and from the base stations so each channel assigned to the radio dispatch system is only used for part of the time. Specifically, a control channel transmitted from each base station is dedicated to the function of sending upstream channel assignments to the mobile transceivers. If there is a lot of traffic on the system, different groups of mobile transceivers maybe assigned to different upstream channels. The control channel typically would change the channel assignment from time to time, even in the middle of the transmission of a message. Similarly, the assigned control channel also changes from time to time. When a control channel change is made, the frequency of the new control channel is transmitted over the control channel about to be taken out of service. The traffic on the various channels is monitored so that the channels bearing the least traffic can be assigned first to the mobile transceivers so as to even out the traffic flow.

The attached appendix describes in further detail the operation of the invention.

The described embodiment of the invention is only considered to be preferred and illustrative of the inventive concept; the scope of the invention is not to be restricted to such embodiment. Various and numerous other arrangements may be devised by one skilled in the art without departing from the spirit and scope of this invention.

What is claimed is:

1. A radio dispatch system comprising:
a plurality of base stations covering a large geographic area;
means for connecting the base stations to the Internet to transmit voice messages there between; and
a plurality of mobile transceivers adapted to send voice messages to one of the base stations and receive voice messages from one of the base stations.
